(19) United States
(12) Patent Application Publication
(10) Pub. No.: US 2005/0005710 A1
(43) Pub. Date: Jan. 13, 2005

(54) Liquid metering system

(75) Inventor: Burton H. Sage JR., Vista, CA (US)

Correspondence Address: FOLEY AND LARDNER;SUITE 500, 3000 K STREET NW, WASHINGTON, DC, 20007, US

(73) Assignee: Therafuse, Inc.

(21) Appl. No.: 10/786,562

(22) Filed: Feb. 26, 2004

Related U.S. Application Data
(63) Continuation-in-part of application No. 10/146,588, filed on May 15, 2002.
(63) Continuation of application No. 10/600,296, filed on Jun. 20, 2003.

(51) Int. Cl. G01F 1/86

(52) U.S. Cl. 73/861.01

(57) ABSTRACT

Systems and methods for measuring the flow of a fluid along a passageway are disclosed. A heat source applies thermal energy to a portion of the fluid thereby elevating its temperature and decreasing its density. An optical sensing means measures a change in a property of illumination directed through the passageway caused by the change in the density of the heated portion of fluid. The time required for the heated portion of the liquid to move from the point of application of thermal energy to the point of optical sensing is measured. This measured time, and the distance of separation of the source of heat and the optical sensor permits calculation of the fluid velocity in the passageway.

This application claims subject matter disclosed in copending application Ser. No. 10/146,588 dated May 15, 2002, copending application Ser. No. 10/600,296 dated Jun. 20, 2003, copending application Ser. No. 10/662,871 dated Sep. 16, 2003, along with the applications from which these copending applications claim priority, the contents of all of these applications (co-pending and priority applications) being incorporated by reference herein in their entirety. This application also claims subject matter disclosed in issued U.S. Pat. No. 6,582,393, issued Jun. 24, 2003, the contents of which are also incorporated by reference herein in their entirety.

### BACKGROUND OF THE INVENTION

A. Field Of The Invention

This invention relates to the measurement of properties of fluids moving in a passageway and specifically the measurement of the flow rate of a fluid.

B. Related Art

Many methods of measuring the flow rate of fluids, and in particular the rate of infusion of a pharmaceutical to a patient are known. Best known are positive displacement systems wherein a known volume of fluid is moved over time independent of other system parameters such as pressure and liquid viscosity. Today, the most commonly used positive displacement pump for accurate infusion of a pharmaceutical to a patient is the syringe pump. A motor moves a plunger down the barrel of a syringe with tightly controlled manufacturing tolerances on inside diameter. The rate of advance of the plunger times the time of advance times the cross-sectional area of the syringe determines the volume of fluid infused. This positive displacement method is used, for example, in the MiniMed Model 508 insulin pump, which typically has a retail price in excess of $5,000.00. A second example of a positive displacement system is the peristaltic pump, where rollers placed against a flexible conduit roll along the conduit to move the fluid down the conduit. In peristaltic pumps, enough force is applied to the liquid in the flexible conduit to eliminate any dependence on pressure and viscosity. However, the volume of liquid dispensed remains dependent on the volume of fluid in the tubing, which depends on the square of the inside diameter of the elastomeric tubing. Since the manufacturing tolerance on the inside diameter of economic elastomeric tubing is on the order of +/−10%, the delivery accuracy is limited to +/−20%. Peristaltic pumps are also expensive, but somewhat less expensive than syringe pumps.

Given the expense of these positive displacement pumps, and the need to find less expensive systems for accurate delivery of pharmaceuticals, other devices and methods have been proposed to maintain the required level of accuracy while reducing the cost. It is clear that many of these proposed systems achieve the goal of reduced expense. However, the problem that these proposed schemes face is that they do not achieve an improved accuracy of delivery of the pharmaceutical. For example, in a liquid dispensing system with a pressurized liquid container where the pressure on the liquid forces it along the conduit, the parameters dictating the flow include the pressure that is causing the liquid to flow, the inside diameter of the conduit along which the liquid is flowing, the length of the conduit, and the viscosity of the liquid, which is in turn dependent on the temperature of the liquid. This problem is further compounded by the fact that the dependence on the inside diameter of the conduit is a fourth power dependence. In many delivery systems of this type, the pressure on the liquid decreases as the amount of liquid in the container decreases, leading to a reduction in the flow rate. The solution to this pressure decrease is known. O'Boyle in U.S. Pat. No. 4,874,386 teaches a liquid dispensing device that accurately controls the pressure in this type of dispensing system by incorporating a constant pressure spring. But the dimensions of the flow conduit, its cross section, and the temperature for viscosity control are left uncontrolled, with the result of inaccurate dispensing of the fluid.

In order to overcome the situation of having to manufacture dispensing system components to higher tolerances than is economically feasible, other methods of measuring the liquid flow rate have been taught. If the actual flow rate is measurable, the flow rate may be adjusted to the desired flow rate. Or, if an accurate total volume rather than flow rate is required, the required time of flow may be calculated using the actual flow rate to achieve the desired volume.

In general, the different types of liquid flow measuring systems can be divided into two classes—those that require contact with the liquid to measure the flow, and those that measure the flow without requiring contact with the liquid. Flow measuring systems in the first class include a) turbines, where the angular speed of the propeller in the stream is a measure of flow rate, b) pressure drop systems, where the pressure difference across a flow resistor is used to calculate the flow rate, and c) certain forms of “thermal time of flight” systems where elements that add heat to the stream and measure heat in the stream are used to measure flow rate. Examples of these “thermal time of flight” systems are taught by Miller, Jr. in U.S. Pat. No. 4,532,811, the contents of which are incorporated by reference herein in their entirety, and by Jerman in U.S. Pat. No. 5,533,412, the contents of which are incorporated by reference herein in their entirety. However, in many liquid delivery systems, the conduit along which the liquid flows requires frequent replacement and, in the case of pharmaceutical infusion systems, the total flow path must also be kept sterile. In this first class of types of flow meters, the added complexity of adding components, and their necessary leads and connectors to the replaceable conduits, causes the replacement conduits to be expensive. And if these additional components are added to a reusable portion of the dispensing system, the replacement of the liquid container, or addition of fresh liquid to an existing container opens the flow path to an unsterile environment. For these reasons, attention has been paid to the second class of flow meters—those that do not require contact with the liquid in the conduit and add complexity to the conduit.

Kerlin, Jr, in U.S. Pat. No. 4,777,368, the contents of which are incorporated by reference herein in their entirety, teaches a method and apparatus for non-contact measurement of the velocity of a moving mass. In an embodiment of the invention, an infrared heat source raises the temperature of an element of the moving mass and an infrared detector, viewing this element of the moving mass at a later time, detects the heated element and records the time required for the moving mass to move from heater to detector. Given the physical separation of the heater and the detector, the speed of the moving mass may be calculated. Kerlin makes reference to the use of this concept for liquids as well as solids. Goldberg, in U.S. Pat. No. 4,938,079, the contents of which are incorporated by reference herein in their entirety, teaches the same basic concept as Kerlin, Jr. with the modification that microwave energy is used to heat the liquid within a conduit and a microwave detector is used to sense the heated liquid downstream from the heater. Frank et al in U.S. Pat. No. 5,211,626, the contents of which are incorporated by reference herein in their entirety, also teaches a thermal time of flight flow metering method, and while at least one infrared detector is used to detect the heated liquid, the liquid is heated by thermal contact with the liquid through the wall of the conduit.

In the teachings of U.S. Pat. No. 4,777,368, the contents of which are incorporated by reference herein in their entirety, U.S. Pat. No. 4,938,079, the contents of which are incorporated by reference herein in their entirety, and U.S. Pat. No. 5,211,626, the contents of which are incorporated by reference herein in their entirety, there are additional practical considerations that make these teachings difficult to reduce to practice in cost-effective commercial products. The first of these practical aspects is the heating of the portion of the liquid to be sensed. Due to the high heat capacity and the rapid thermal diffusivity of many liquids of commercial importance, and especially water, which is the base of virtually all pharmaceutical infusion fluids, heating the liquid fast enough to realize an operational flow meter is very difficult. Kerlin, Jr. in U.S. Pat. No. 4,777,368, the contents of which are incorporated by reference herein in their entirety, implicitly recognizes this by advocating a high power CO2 laser. Neither Frank in U.S. Pat. No. 5,211,626, the contents of which are incorporated by reference herein in their entirety, nor Goldberg, in U.S. Pat. No. 4,938,368, the contents of which are incorporated by reference herein in their entirety, recognize this problem. And the problem is especially acute for Frank since his teachings require the heat to pass through the wall of the conduit by conduction, which is especially time-consuming and lossy. One solution to this problem, which is not alluded to in any of these three teachings, is to stop the flow of the liquid and to heat the liquid while it is stationary. The flow rate is measured by restarting flow once the liquid is heated. The two advantages of stopping the flow to heat the liquid is that the total mass of liquid that must be heated is greatly reduced and the heat pulse is relatively confined in position along the conduit. This solution is taught in U.S. Pat. No. 6,582,393 which, as noted above, the contents of which are incorporated by reference herein in their entirety,.

The second practical aspect that makes some prior devices difficult to commercialize is the mode of detecting the heat pulse. Many pharmaceutical solutions, especially protein solutions such as insulin, degrade at temperatures above room temperature, and begin to denature at temperatures above 40 degrees centigrade. An exemplary temperature rise that might avoid such a problem would be less than 5 centigrade degrees above ambient.

Detection methods relying on detecting the infrared radiation from such a small change in temperature usually need to operate in the far infrared where detectors are either too slow to respond to the heated liquid or must be cooled, making them large, energy consuming and expensive. Yin and Templin in U.S. Pat. No. 6,386,050, the contents of which are incorporated by reference herein in their entirety, teach an improved thermal time of flight flow monitor that uses a visible light source to detect the presence of heated liquid. In this way, the need for far infrared detectors is avoided. While this method of Yin and Templin may obviate the need for far infrared detectors, it requires a passageway with walls that are essentially optically smooth and flat. Such passageways are relatively expensive, making them unsuitable for systems that need disposable fluid passageways such as drug infusion systems.

Thus there continues to be a need for improved devices and methods for accurate and economical measurement of liquid flow in liquid dispensing systems, especially in the area of infusion of pharmaceutical solutions.

An object of the current invention is to provide an accurate, inexpensive, and practical system and method for measuring the velocity of a liquid in a conduit.

It is a further object of the current invention to use this system and method for measuring the velocity of a liquid in a conduit to infuse pharmaceutical solutions. This velocity may be used for either accurate delivery of the pharmaceutical solutions or, when zero flow rate is measured, to detect occlusions in the delivery system.

It is yet another object of the current invention to provide an accurate, inexpensive and practical system and method for detecting and measuring the temperature of a liquid in a conduit.

### SUMMARY OF THE INVENTION

The present invention provides for a device and method for measuring the time of flight and/or the velocity of a fluid moving in a conduit. The fluid may be a material in the gaseous state or in the liquid state. The apparatus includes a passageway, a portion of which transmits optical radiation. The optical radiation may be ultraviolet, visible, or infrared. A source of heat is positioned to heat a portion of the fluid at a first location in the passageway. The fluid may be in motion or at rest. The heated portion of the fluid as it flows downstream has physical dimensions that are small compared to the dimensions of the cross-section of the passageway. In this context, a small physical dimension is one such that at its edges, the temperature profile of the heated portion results in no substantial increase in temperature at the passageway wall. Downstream from this first location at a second location a light source directs a beam of coherent light onto the fluid in the passageway. The heated portion of the liquid flows through the illumination at the second location, creating a phase object in the beam of illumination. At the second location, a portion of the illumination is diffracted due to the phase object created by the change in density of the heated portion of the liquid. A detector is positioned to detect a change in intensity of the illumination due to the diffraction of the illumination when the heated portion of the fluid passes through the illumination.

The heating of the portion of the fluid at the first location may occur at a first time. The detection of the heated portion of the fluid when it passes through the illumination at the downstream second location occurs at a second later time. When the time difference between the second time and the first time (the thermal time of flight) is divided into the distance of separation between the first location and the second location, a velocity of the liquid is calculated.

Other aspects and advantages of the invention will become apparent from the following detailed description and drawings of the invention.

### BRIEF DESCRIPTION OF THE DRAWINGS

FIG. 1 is a functional block diagram of a liquid dispensing system with a flow meter designed according to the invention.

FIG. 2 is an optical schematic of the liquid flow meter of FIG. 1 showing an increment of liquid being heated.

FIG. 3 is an optical schematic of the liquid flow meter of FIG. 1 showing a heated increment of fluid flowing toward a position where it can be detected by diffraction of light.

FIG. 4 is an optical schematic of the liquid flow meter of FIG. 1 showing the heated increment of fluid in a position where it can be detected by diffraction of light. FIG. 5 is a time sequence of the output of a line array detector showing the far field pattern of light before, during, and after the passage or presence of a heated increment of liquid.

FIG. 6 is the output of a line array detector showing the far field pattern of light at a time before the passage of the heated fluid and at a time during the passage of the heated fluid.

### DETAILED DESCRIPTION OF THE INVENTION

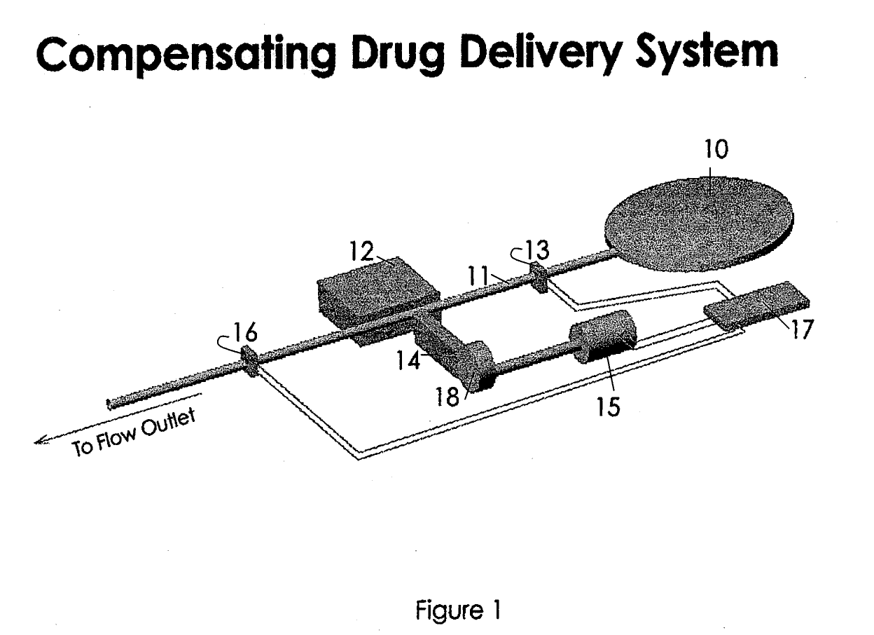

The optical flow meter of this invention will be described in terms of a liquid dispensing system for use in infusion of pharmaceutical solutions, but may be applied in a number of contexts outside of the pharmaceutical space, such as monitoring the flow of liquids in liquid chromatography systems or in monitoring the flow of liquids in a carburetion system, and including non-liquid applications. FIG. 1 shows a block diagram of a system for infusing pharmaceuticals. The liquid to be dispensed is contained in pressurized reservoir 10. When pinch tube member 14 is moved away from stop 12, conduit 11 is opened and the liquid is free to flow down conduit 11 to the flow outlet, which may include one or more microneedles (not shown). When pinch tube member 14 presses conduit 11 against stop 12, stopping flow, the liquid is not free to move down the conduit 11 to the flow outlet.

At a selected time, microprocessor 17 signals heating element 13 to heat a portion of the liquid at its location along the conduit 11. Once the portion of the liquid is heated, the pinch tube member 14 is moved away from the conduit 11, for example, by and instruction from microprocessor 17 to pinch tube actuator 15 which rotates cam 18 such that pinch tube member 14 moves away from flow tube 11, and the liquid begins to flow. Alternately, at a selected time microprocessor 17 signals pinch tube actuator 15 and cam 18 to open flow tube 11 by moving pinch tube member 14 away from flow tube 11. Once the fluid is flowing in flow tube 11, microprocessor 17 signals heating element 13 to heat a portion of the liquid at its location along the conduit.

At some later time after the heating of this portion of the liquid, the heated portion of the liquid passes heat sensor 16 where the heated portion is detected. The time required for the heated portion of the liquid to move from the location of the heater 13 to the heat sensor 16 is measured. Additionally, the velocity of the liquid may be calculated by dividing the distance between the heating element 13 and the heat sensor 16 by the measured elapsed time.

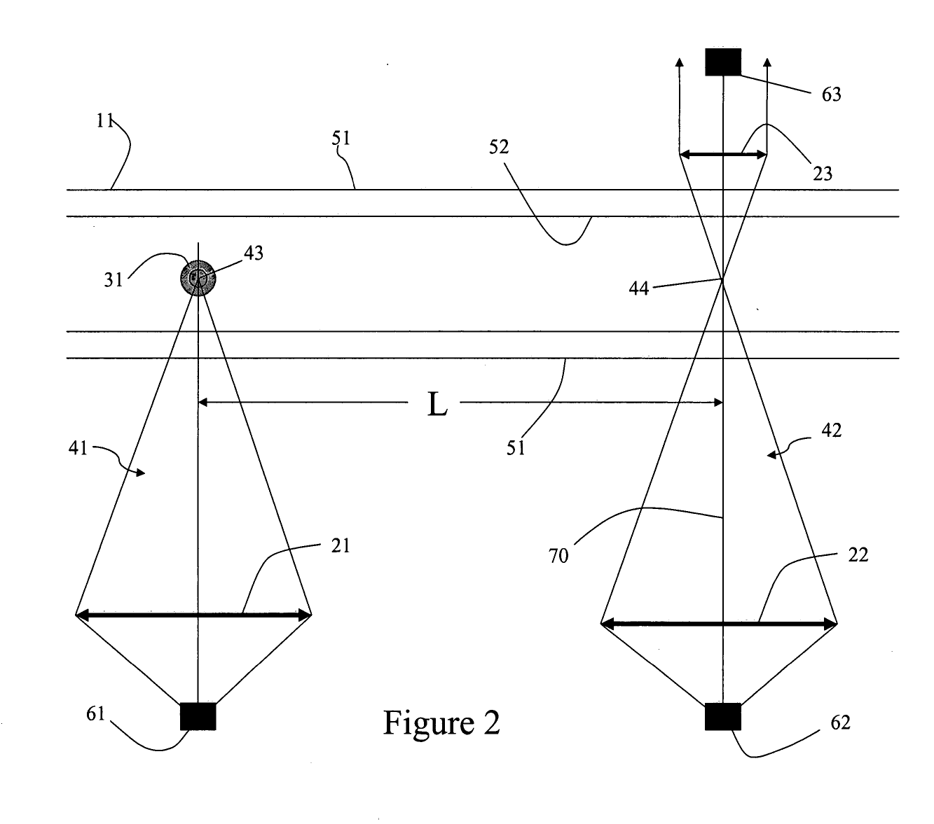

An embodiment of the invention is shown in further detail in FIGS. 2 through 4. In FIG. 2, flow tube 11 is now shown with flow tube walls 51 and passageway 52. Flow along the passageway can be laminar, but may be non-laminar as long as the flow profile is such that the velocity of flow in the center of the passageway is higher than the velocity of flow near the walls of the passageway. A beam generated by heat source 61 is focused by lens 21 such that the heating element of heat source 61 is focused at location 43 in passageway 52 to heat increment of liquid 31. Optical rays indicated generally at 41 illustrate this focusing. As can be seen in FIG. 2, the heated increment of liquid 31 is small compared to the dimensions of passageway 52 in flow tube 11. Heat source 61 may be any source of optical radiation which is capable of being focused by lens 21 such as a laser or tungsten filament or thermal emitter. Such optical radiations include, but are not limited to, infra red and ultraviolet radiation. Still further, embodiments using other sources of radiation, such as microwave radiation, may be used to practice the present invention. Heat source 61 can be an infrared laser, and further can be a solid state infrared laser that emits energy of a wavelength where the fluid is relatively highly absorbing. When the fluid is water, the absorption bands are located near 1470 nm, 1900 nm, and 3000 nm.

As can be further seen in FIG. 2, a second optical source 62 is located downstream of optical source 61. Pinch tube member 14 may be positioned between optical sources 61 and 62 (not shown in FIGS. 2 through 4 but shown in FIG. 1), or both optical sources may be upstream or downstream of pinch tube member 14 (not shown). A beam generated by optical source 62 is focused into a region of passageway 52 by lens 22. Optical rays indicated generally at 42 illustrate this focusing. Rays 42 after passing through the liquid at location 44 are then collected by lens 23. The lens 23 is placed along the optical axis 70 formed by rays 42 a distance of one focal length from location 44, although other embodiments may utilize a distance of less than one focal length or more than one focal length. Detector 63 is also placed on the optical axis 70 formed by rays 42 to collect a portion of the light from optical source 62. Optical axis 70 is shown passing through passageway 52 along a path perpendicular to passageway 52. Perpendicular passage through the passageway is advantageous in some embodiments, but not required in other embodiments. Optical axis 70 may pass through the passageway at other angles. Optical source 62 can be a visible laser, but may be any coherent source with sufficiently long coherence length.

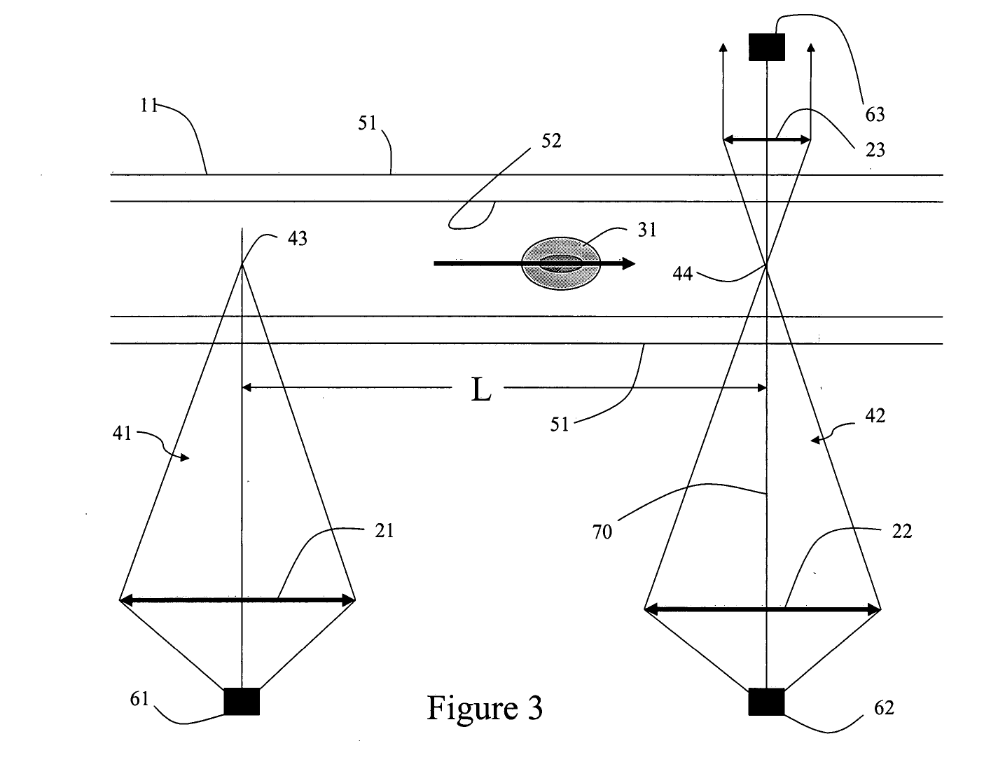

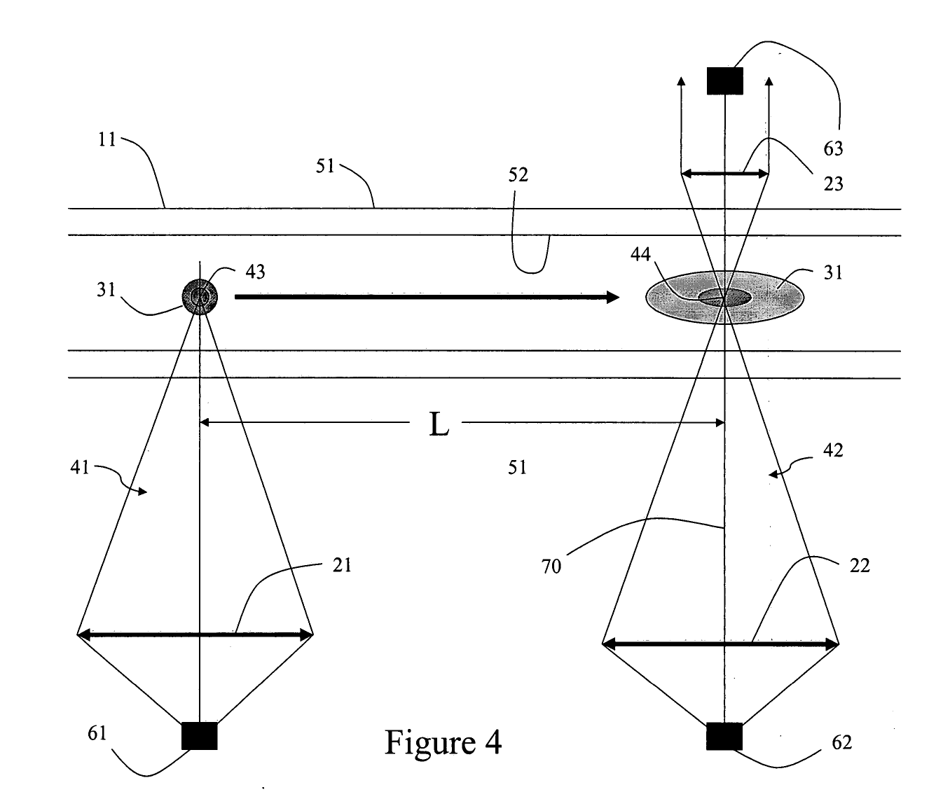

FIG. 3 is essentially the same as FIG. 2 except that FIG. 3 shows heated increment of liquid 31 downstream from position 43 where it was heated. As can be seen in FIG. 3, heated increment of fluid has grown in size due to the diffusion of heat from the original heated volume to the cooler surrounding liquid. Despite this increase in size, the heated increment of fluid remains localized near the center of passageway 52.

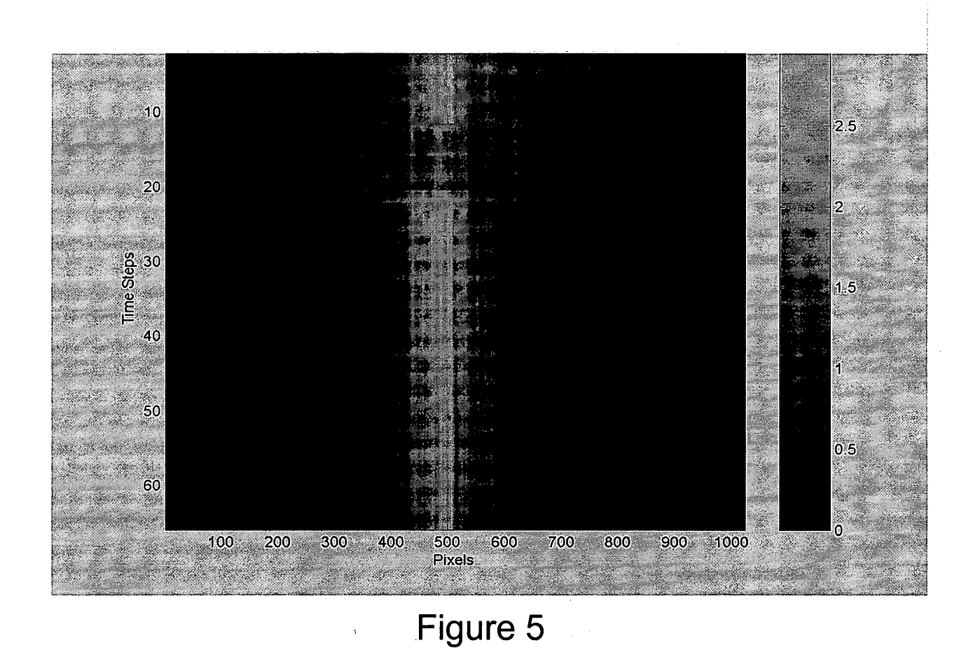

FIG. 4 is also essentially the same as FIG. 3 except that FIG. 4 shows heated increment of liquid 31 further downstream and at location 44 where it passes through the focal point of optical rays 42 from optical source 62. At this point, light from optical source 62 is diffracted, changing the intensity of light at detector 63.

The change in intensity can be sensed, detected, or measured in a number of ways known in the art. For example, one may process the output of detector 63 by placing a threshold detector in the circuit that receives the output of the detector. In such an embodiment, the presence of heated increment of fluid 31 would be determined when the detector output exceeded the threshold. Further by way of example, one may process the output of detector 63 using a peak detector. In such an exemplary embodiment, the presence of heated increment of fluid 31 would be determined when the detector output reached a peak value. Alternatively, by way of example, one may record the output of the detector using an analog to digital converter as is known in the art and store the digitized signal. In this way a number of mathematical properties of the signal can be calculated. These include, but are not limited to the centroid of the signal, the width of the signal, and any number of moments of the signal. These properties may be used to locate the signal in time and to characterize the signal for use in determining the point in time that best represents when the heated increment of fluid passed detector 63. It is noted here that the heated increment of fluid 31 can be considered to have a centroid of diffraction, where the greatest diffraction of a beam passed through the heated increment occurs.

The sequence of FIGS. 2, 3, & 4 illustrate an important aspect of the invention. Shown schematically in FIGS. 2, 3, & 4 is the shape of the heated increment when the average liquid velocity is relatively high and the parabolic velocity profile of laminar flow with the highest flow velocities in the center of the tube results in the heated portions of the fluid nearest the center of the tube being transported downstream relatively quickly. In this case, the heated increment loses most of its heat to surrounding liquid and loses an insignificant amount of heat through the passageway wall. Under these circumstances, the temperature profile of the liquid across the passageway downstream from the heating location will be non-uniform with the highest temperatures in the center of the passageway. Stated slightly differently, the heated increment of liquid raises the temperature of the liquid at the wall of the passageway an insignificant amount since most of the heat is carried downstream in the center of the tube. This aspect of insignificant temperature rise at the wall during movement of the heated increment downstream is especially true at the sensing region.

Contrast this effect of the highest temperature liquid staying near the center of the passageway at relatively high average flow rates with the effect at relatively low average flow rates. At relatively low average flow rates, by thermal diffusion, the heat will flow to the walls of the passageway and escape through the walls of the passageway. Very little heat is carried downstream by the liquid. At relatively low average flow rates, then, a significant temperature rise occurs at the wall of the passageway. Whether the average flow rate is relatively high or relatively low is determined by the thermal diffusivity of the liquid and the geometry of a given passageway. If the time required for the heat to move to the passageway wall perpendicular to the direction of flow is greater than the time required for the stream to carry the heated liquid the same distance downstream, then the average flow rate is relatively high. Otherwise, the average flow rate is relatively low. This invention is well suited to systems with relatively high average flow rates as defined here. Note well, however, that the average flow rate is highly dependent on the dimensions of the passageway. A system with a relatively low average flow rate with one set of passageway dimensions (length and inside diameter or if the passageway is square or rectangular, the height and width) may become a system with a relatively high average flow rate with another set of passageway dimensions.

In a system with a relatively high flow rate, that is, one where the heat introduced into the fluid does not leave the fluid primarily through the walls of the passageway but instead primarily stays in the fluid, the temperature profile is such that the hottest fluid is at or near the center of the passageway. Still, it is noted that other embodiments of the present invention may be practiced where heat does leave through the walls, as long as the fluid retains a sufficient amount of heat such that diffraction may be used to analyze the flow of fluid. This is especially true when flow along the passageway is laminar. The contours of heated increment 31 as shown in FIGS. 2, 3, and 4 are then interpretable as isotherms, that is, points of equal temperature. As can be seen from the profiles shown in FIGS. 2, 3, and 4, there are high temperature gradients along paths from unheated fluid to the hottest portions of the heated fluid increments. As the temperature of the fluid changes, so does the density of the fluid. From an optics point of view, these density variations represent regions where the phase of an incident light beam is changed. These density variations diffract an incident beam resulting in variations in the intensity of the beam as it proceeds from the passageway.

FIG. 5 shows data from a prototype of the liquid metering system and, more particularly, a diffraction pattern generated after the liquid has been illuminated by the light source 62. This prototype system comprised a semiconductor heat laser operating at 1.47 microns with an exit aperture of 1 micron by 5 microns. This semiconductor laser illuminated the fluid flowing in a passageway, the passageway having dimensions of 50 microns by 50 microns. The heat laser was focused so that it perpendicularly illuminated a cylinder through the passageway about 20 microns in diameter. The sense laser was a 630 nm semiconductor laser focused on the passageway 200 microns downstream of the heat laser. The size of the focused spot was about 30 microns in diameter. When the liquid passing down the passageway is all the same temperature, there is a time invariant diffraction pattern. The diffraction pattern changes upon interaction with the heated increment of liquid. To obtain FIGS. 5 & 6, a line array of photodiodes has been used as detector 63 in FIG. 4 and has been placed so that the axis of the line array is perpendicular to both the illumination axis and the passageway. A sequence of 65 data sequences of the line array is shown in FIG. 5, with the first output shown at the top of FIG. 5, and the final output, output 65, shown at the bottom. Each output shows the intensity of the light at the position of detector 63 in FIG. 4 for each of the 1012 individual detectors of the line array. Each line output, from the top of FIG. 5 to the bottom of FIG. 5, represents the intensity of the light at subsequent increments of time, each increment representing one hundred microseconds. In the experiment shown in FIG. 5, the liquid is moving in the passageway, and the liquid was heated for about one millisecond. As can be seen from FIG. 5, the heated increment of liquid appears at location 44 about a millisecond and a half after being heated, as evidenced by the much broader pattern of light due to the diffraction caused by the presence of the heated increment of liquid. If detector 63 were positioned along and centered on axis 70 as shown in FIG. 4 (at approximately pixel position 500), detector 63 would detect a lower intensity of light due to the passage of the heated increment of liquid, as represented by less bright pixels shown between about pixel positions 400 to 500. If detector 63 were placed off axis 70 in the location of pixels 325 through 375, the passage of the heated increment of liquid would result in an increase in light intensity at detector 63.

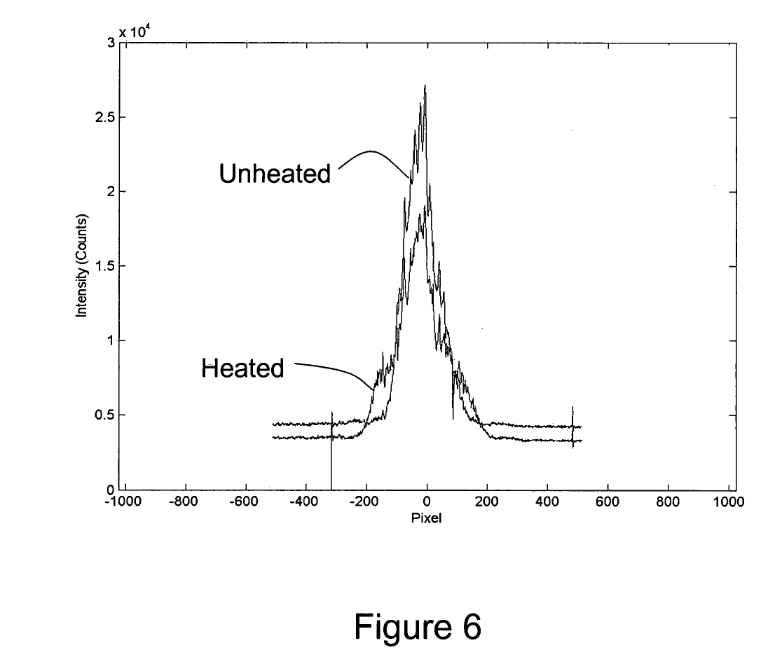

FIG. 6 shows the intensity of illumination at detector location 63 of two selected sequences from the 65 sequences of the output of the line array shown in FIG. 5. The intensity profile labeled “heated” was selected from those sequences between sequence 12 and sequence 20. The sequence labeled “unheated” was selected from those sequences up to sequence 12. As can be seen from these sequences, placing a detector on axis 70, represented by pixel 0 in FIG. 6, would result in a signal that decreases in intensity as the heated increment passes. Alternate locations for an “on-axis” detector would be at pixel locations from about location −100 to location +10. This “on-axis” detector may be sized to cover as many or as few of these pixels as may provide the signal with the highest signal to noise. Alternately, detector 63 may be placed off axis, such as in the direction of negative pixels as shown in FIG. 6 from about pixel −200 to pixel −100. Detector 63 at this location would detect an increased signal when the heated increment passed through the beam from light source 62. This “off-axis” detector may be sized to cover as many or as few of these pixels as may provide the signal with the highest signal to noise.

The optical sensor shown in FIGS. 2 through 4 operates in the following way. At a desired point in time, light source 62 is activated to heat a small increment of liquid at location 43. The liquid may or may not be flowing at this time. If the liquid is not flowing, flow is initiated at a known time after the liquid is heated. Heated increment of liquid 31 then flows along the passageway, as shown in FIG. 3, expanding as it flows due to thermal diffusion. At some later time it reaches location 44 in passageway 52 as shown in FIG. 4. However, heated increment 31 has not yet expanded to the point where the temperature of the liquid is raised significantly at passageway wall 51, if at all. Because heated increment 32 has an elevated temperature relative to other nearby regions of the liquid in passageway 52, the density of the liquid in liquid increment 32 is lower than the liquid in nearby regions of passageway 52. In this way heated increment 32 represents an optical phase object and causes light from optical source 62 to be diffracted as it passes location 44. The diffraction of the light from optical source 62 due to the passage of phase object 32 through the light from optical source 62 at location 44 causes a change in the far-field intensity pattern of light source 62. By placing lens 23 one focal length from location 44 along the optical axis of rays 42 from optical source 62, this far-field intensity pattern can be imaged at detector 63. In this way detector 63 will sense the passing of phase object 32 due to the change in the far-field intensity pattern caused by phase object 32. Detector 63 may be placed on optical axis 70, where it would detect a decrease in light intensity as the heated increment passes, or off axis 70 perpendicular to both optical axis 70 and the axis formed by the passageway, where it would detect an increase in light intensity.

In FIGS. 2 through 4, the separation distance of locations 43 and 44 is either predetermined, known or measured. In a first embodiment, the fluid is not flowing when an increment of fluid is heated by heat source 61. Shortly after heating the increment of fluid, flow is started. The time required for the heated increment of fluid to flow from location 43 where it was heated to location 44 where it is detected is measured as the elapsed time from the time of starting fluid flow to the time of detection of the heated increment at location 44. This time interval is termed the thermal time of flight. The velocity of the fluid may be calculated by dividing the thermal time of flight into the separation distance.

In a second embodiment of FIGS. 2 through 4, the fluid is flowing at the time an increment of fluid is heated at location 43. At a desired time after initiation of flow, an increment of fluid is heated, and the elapsed time from time of heating to time of detection at location 44 is measured to determine the thermal time of flight. The velocity of the fluid may be calculated by dividing the thermal time of flight into the separation distance.

Further embodiments may be envisioned to take advantage of the invention. In one such embodiment, a second optical source and detector pair for detecting the heated increment of liquid is located at a third location downstream of location 44 in FIGS. 2 through 4. In such an embodiment, the thermal time of flight may be measured as the elapsed time for the heated increment to move from location 44 to the third location further downstream. And the fluid velocity may be calculated as the thermal time of flight divided into the distance of separation of the two optical source detector pairs.

In any of the possible embodiments of the invention, the details of the passageway are not critical as long as the walls of the passageway where the fluid is heated allows sufficient energy to pass such that the fluid is heated or, where the heated fluid is sensed, allows sufficient illumination to pass through such that the coherence of the beam is maintained and the heated increment is sensed. The passageway may be circular, or square, or even rectangular. The passageway may be made of any of a multitude of glasses or from any of a number of engineering polymers.

The descriptions of the optical systems set forth herein are meant to be illustrative and not definitive. Persons skilled in the art may be able to provide variations on the basic design of these optical systems in the detecting and measuring of a heat pulse in a liquid in a conduit and the subsequent measurement of the flow of the liquid in the conduit.

Further, the descriptions of the optical systems and metering systems herein may be implemented in combination with the teachings of one or more of the above referenced patents incorporated herein by reference to deliver/dispense liquid. For example, the metering systems and optical systems described herein can be used in combination with the liquid delivery components described in those patents.

1. A system for monitoring fluid flow through a passageway comprising:
a) a heater that heats a portion of the fluid in the passageway;
b) a light source that generates a beam of light that illuminates the fluid in the passageway; and
c) a light detector positioned to receive a portion of the beam, wherein the detector measures a change in the intensity of the beam caused by diffraction of the beam when the heated portion of the fluid passes through the beam.

2. The system of claim 1 wherein the beam has an axis and the light detector is positioned along the axis such that the light detector measures a decreased intensity with the passage of the heated portion of the fluid.

3. The system of claim 1 wherein the beam has an axis and the light detector is displaced from the axis such that the light detector measures an increased intensity with the passage of the heated portion of the fluid.

4. The system of claim 1 wherein the beam has an axis and the fluid in the passageway has a non-uniform temperature profile along the axis when the heated portion of the fluid passes through the beam.

5. The system of claim 1 wherein the heater is an infrared laser.

6. The system of claim 1 wherein the fluid is a liquid.

7. The system of claim 1 wherein the heater is positioned a known distance upstream of the location where the beam passes through the passageway.

8. The system of claim 7 further comprising a processor that measures a time period between heating of the portion of the fluid and detection of the passage of the heated portion of the fluid by the light detector.

9. The system of claim 8 wherein the processor calculates a velocity of the fluid from the time period and the known distance between the heater and the light source.

10. A system for monitoring fluid flow comprising:
a) a passageway along which the fluid may flow such that the average flow rate is relatively high,
b) a heat source that heats a portion of the fluid in the passageway at a first position along the passageway,
c) a source that generates a light beam that illuminates the fluid in the passageway at a second position downstream from the first position, and
d) a light detector positioned to receive illumination from the source and to detect a change in intensity of the received illumination when the heated portion of the fluid passes through the beam.

11. The system of claim 10 wherein the beam has an axis and the light detector is positioned along the axis such that the light detector measures a decreased intensity with the passage of the heated portion of the fluid.

12. The system of claim 10 wherein the beam has an axis and the light detector is displaced from the axis such that the light detector measures an increased intensity with the passage of the heated portion of the fluid.

13. The system of claim 10 wherein the beam has an axis and the fluid in the passageway has a non-uniform temperature profile along the axis when the heated portion of the fluid passes through the beam.

14. The system of claim 10 further comprising a processor that measures a time period between heating of the portion of the fluid and detection of the passage of the heated portion of the fluid by the light detector.

15. The system of claim 14 wherein the processor calculates a velocity of the fluid from the time period and the known distance between the heater and the light source.

16. The system of claim 10 further comprising a second light source-detector pair positioned downstream of the first-named light source and the first-named light detector such that the processor measures a time period between detection of the passage of the heated portion of the fluid by the first-named light detector and detection of the passage of the heated portion of the fluid by the second light source-light detector pair.

17. A system for monitoring flow of a liquid through a passageway, comprising:
a heat laser that generates a first beam directed toward the passageway wherein the first beam is focused to a region at a first location within the passageway such that a localized portion of the liquid in the passageway is heated and the liquid in the passageway has a non-uniform temperature cross-section;
a sense laser that generates a second beam directed toward and focused on the passageway at a second location downstream from the first location such that the heated localized portion of the liquid will be illuminated by the second beam when the heated localized portion flows through the second beam; and
a light detector positioned to receive a portion of the second beam when the heated localized portion of the liquid passes through the second beam.

18. The system of claim 17 wherein the second beam has an axis and the light detector is positioned along the axis such that the light detector measures a decreased intensity with the passage of the localized portion of the liquid.

19. The system of claim 17 wherein the second beam has an axis and the light detector is displaced from the axis such that the light detector measures an increased intensity with the passage of the localized portion of the liquid.

20. A method of measuring flow of a liquid in a passageway, the method comprising:
a) heating a portion of the liquid in the passageway at a first position,
b) directing a beam of light from an optical source into the liquid in the passageway at a second position downstream from the first position, and
c) detecting a change in intensity in of the light from the optical source caused by diffraction of a portion of the beam when the heated portion of the fluid passes through the beam.

21. The method of claim 20 wherein the beam has an axis and the detecting action comprises measuring a decreased intensity with the passage of the heated portion of the fluid with a detector place on the axis.

22. The method of claim 20 wherein the beam has an axis and the detecting action comprises measuring an increased intensity with the passage of the heated portion of the fluid with a detector displaced from the axis.

23. The method of claim 20 further comprising measuring a time period between the heating action and detection of the passage of the heated portion of the fluid by the light detector.

24. The method of claim 23 further comprising calculating a velocity of the fluid from the time period and a distance between the first and second positions.

25. The system of claim 1, wherein the light detector is positioned to receive substantially all of a portion of the beam that passes through the entire passageway, wherein the detector measures a change in the intensity of a localized portion of the received beam caused by diffraction of the beam induced by the heated portion of the fluid.

26. A device for delivery of a liquid medicament to a subject comprising:
a system for monitoring fluid flow through a passageway according to claim 1; and
a valve for starting and stopping liquid flow in the flow tube in a periodic manner based on information from the system.

27. A device for delivery of a liquid medicament to a subject comprising:
a system for monitoring fluid flow through a passageway according to claim 9; and
a valve for starting and stopping liquid flow in the flow tube in a periodic manner based on information from the system.

28. A device for delivery of a liquid medicament to a subject comprising:
a system for monitoring fluid flow through a passageway according to claim 10; and
a valve for starting and stopping liquid flow in the flow tube in a periodic manner based on information from the system.

29. A device for delivery of a liquid medicament to a subject comprising:
a system for monitoring fluid flow through a passageway according to claim 16; and
a valve for starting and stopping liquid flow in the flow tube in a periodic manner based on information from the system.

30. A device for delivery of a liquid medicament to a subject comprising:
a system for monitoring fluid flow through a passageway according to claim 17; and
a valve for starting and stopping liquid flow in the flow tube in a periodic manner based on information from the system.

31. The method of claim 20 further comprising starting and stopping the fluid based on the detected change in intensity.

32. The method of claim 24 further comprising starting and stopping the fluid based on the calculated velocity.

33. The system of claim 17 wherein the light detector senses or measures a change in the intensity of the second beam.

34. A system for monitoring fluid flow through a passageway comprising:
a) a heater that heats a portion of the fluid in the passageway;
b) a light source that generates a beam of light that illuminates the fluid in the passageway; and
c) a light detector positioned to receive a portion of the beam, wherein the detector senses a change in the intensity of the beam caused by diffraction of the beam induced by the heated portion of the fluid.

35. The system of claim 34 wherein the beam has an axis and the light detector is positioned along the axis such that the light detector senses a decreased intensity with the passage of the heated portion of the fluid.

36. The system of claim 34 wherein the beam has an axis and the light detector is displaced from the axis such that the light detector senses an increased intensity with the passage of the heated portion of the fluid.

37. The system of claim 34 wherein the beam has an axis and the fluid in the passageway has a non-uniform temperature profile along the axis when the heated portion of the fluid passes through the beam.

38. The system of claim 34 wherein the heater is positioned a known distance upstream of the location where the beam passes through the passageway.

39. The system of claim 38 further comprising a processor that measures a time period between heating of the portion of the fluid and detection of the passage of the heated portion of the fluid by the light detector.

40. The system of claim 39 wherein the processor calculates a velocity of the fluid from the time period and the known distance between the heater and the light source.

41. The system of claim 17 wherein the second beam has an axis and the light detector is positioned along the axis such that the light detector senses a decreased intensity with the passage of the localized portion of the liquid.

42. The system of claim 17 wherein the second beam has an axis and the light detector is displaced from the axis such that the light detector senses an increased intensity with the passage of the localized portion of the liquid.

43. A method of measuring flow of a liquid in a passageway, the method comprising:
a) heating a portion of the liquid in the passageway at a first position,
b) directing a beam of light from an optical source into the liquid in the passageway at a second position downstream from the first position, and
c) measuring a change in intensity in of the light from the optical source caused by diffraction of a portion of the beam when the heated portion of the fluid passes through the beam.

44. The method of claim 43 wherein the beam has an axis and the measuring action comprises measuring a decreased intensity with the passage of the heated portion of the fluid with a detector place on the axis.

45. The method of claim 43 wherein the beam has an axis and the measuring action comprises measuring an increased intensity with the passage of the heated portion of the fluid with a detector displaced from the axis.

46. The method of claim 43 further comprising measuring a time period between the heating action and the measurement of the change of intensity.

47. The method of claim 46 further comprising calculating a velocity of the fluid from the time period and a distance between the first and second positions.

48. The system of claim 34, wherein the light detector is positioned to receive substantially all of a portion of the beam that passes through the entire passageway, wherein the detector senses a change in the intensity of a localized portion of the received beam caused by diffraction of the beam induced by the heated portion of the fluid.

49. A device for delivery of a liquid medicament to a subject comprising:
a system for monitoring fluid flow through a passageway according to claim 34; and
a valve for starting and stopping liquid flow in the flow tube in a periodic manner based on information from the system.

50. A device for delivery of a liquid medicament to a subject comprising:
a system for monitoring fluid flow through a passageway according to claim 40; and
a valve for starting and stopping liquid flow in the flow tube in a periodic manner based on information from the system.

51. The method of claim 43 further comprising starting and stopping the fluid based on the detected change in intensity.

52. The method of claim 47 further comprising starting and stopping the fluid based on the calculated velocity.
